(19) United States
(12) Patent Application Publication
(10) Pub. No.: US 2025/0112255 A1
(43) Pub. Date: Apr. 3, 2025

(54) METHOD FOR OPERATING A FUEL CELL SYSTEM, AND A CONTROL DEVICE

(71) Applicant: Robert Bosch GmbH, Stuttgart (DE)

(72) Inventors: Timo Bosch, Renningen (DE); Tobias Falkenau, Esslingen (DE)

(21) Appl. No.: 18/729,027

(22) PCT Filed: Jan. 18, 2023
(86) PCT No.: PCT/EP2023/051075

§ 371 Date: Jul. 15, 2024

(30) Foreign Application Priority Data
Jan. 20, 2022 (DE) 10 2022 200 638.0

(51) Int. Cl. H01M 8/04119; H01M 8/04089; H01M 8/0444; H01M 8/04492; H01M 8/04828; H01M 8/10

(52) U.S. Cl. CPC H01M 8/04156; H01M 8/04097; H01M 8/04462; H01M 8/04492; H01M 8/04843; H01M 2008/1095

(57) ABSTRACT

The invention relates to a method for operating a fuel cell system, wherein hydrogen-containing anode gas exiting at least one fuel cell is recirculated via an anode circuit (1), wherein liquid water (2) contained in the anode gas is separated with the aid of a water separator (3) integrated into the anode circuit (1), is collected in a container (4), and is removed from the container (4) by opening a drain valve (5), and the anode circuit (1) is flushed by opening a purge valve (6) integrated into the container (4) of the water separator (3), wherein the hydrogen content is measured with the aid of a hydrogen sensor (7) connected downstream of the purge valve (6). According to the invention, when the purge valve (6) is open and a delayed increase in the hydrogen content is detected with the aid of the hydrogen sensor (7), the “container full” state is detected.

The invention also relates to a control device (8) for carrying out the method or individual method steps.

### BACKGROUND

The invention relates to a method for operating a fuel cell system, in particular a polymer electrolyte membrane (PEM) fuel cell system. Furthermore, the invention relates to a control device configured so as to carry out steps of the method.

PEM fuel cell systems use oxygen to convert hydrogen into electrical energy, heat, and water. “Conversion of hydrogen” means that hydrogen molecules are consumed or removed on the anode side.

A PEM fuel cell consists of an anode, which is supplied with hydrogen, and a cathode, which is supplied with air as an oxygen source. The polymer electrolyte membrane is located between the anode and the cathode. Several such individual cells are stacked in practical applications in order to increase the electrical voltage generated. Within this stack there are several channels through which the individual fuel cells are supplied with hydrogen and air and through which depleted anode gas and depleted humid air are removed.

Special water separators are used to separate liquid water, which is produced during the electrochemical reaction in the fuel cells, from the gaseous part of the anode exhaust gas. In addition to the separation function, the water separator has the task of collecting separated water in a container. When the container is full, the water is drained out by opening a valve, the so-called drain valve.

Nitrogen is transferred from the cathode side to the anode side by diffusion processes. Nitrogen is an inert gas for fuel cells. It reduces the cell voltage and thus the stack voltage, which results in a loss of efficiency. In order to reduce the nitrogen content, anode gas is therefore repeatedly discharged from the anode chamber. The purge is carried out by opening another valve, the so-called purge valve.

Fresh hydrogen is supplied via a dosing valve, which is usually designed as a proportional valve. The control strategy uses this valve to regulate the gas pressure to a defined setpoint pressure depending on the system operating point. A pressure sensor is used to measure the gas pressure at a defined position in the anode chamber. Reasons for supplying fresh hydrogen via the metering valve may be that a) hydrogen has been consumed by the electrochemical reaction in the fuel cells, b) hydrogen has been lost, for example by opening the purge valve and/or opening the drain valve for too long, so that gas has been discharged after the water separator container has been completely emptied.

Fuel cell systems in which the drain valve and purge valve are integrated into the water separator container are known from the prior art. In this case, the drain valve is positioned on the floor side to ideally only drain water. The purge valve, on the other hand, is positioned above a maximum liquid level in order to discharge gas and not water. Since gas discharged from the anode chamber contains residual amounts of hydrogen, it is introduced into a cathode exhaust air path of the system for dilution. There, the gas mixes with the cathode exhaust air so that dangerously high hydrogen concentrations are avoided. For safety reasons, the hydrogen content in the cathode exhaust air path is usually monitored using a hydrogen sensor.

### SUMMARY

The invention is based on the task of specifying a method for operating a fuel cell system that enables full detection of the container of a water separator in a simple manner, so that the ideal time for opening the drain valve can be determined as precisely as possible. A level sensor should not be used, as fluctuations and/or vibrations can influence the measurement result, especially in mobile applications. In addition, a level sensor increases the costs.

In order to solve this problem, the method having the features of the disclosure is proposed. In addition, a control device for carrying out the method or individual method steps is specified.

In the proposed method for operating a fuel cell system, hydrogen-containing anode gas escaping from at least one fuel cell is recirculated via an anode circuit. Liquid water contained in the anode gas is separated with the aid of a water separator integrated into the anode circuit, collected in a container and removed from the container by opening a drain valve. In the method, the anode circuit is purged by opening a purge valve integrated in the water separator container, wherein the hydrogen content is measured with the aid of a hydrogen sensor connected downstream of the purge valve. According to the invention, when the purge valve is open and a delayed increase in the hydrogen content is detected with the aid of the hydrogen sensor, the “container full” state is detected.

There is always a delayed increase in the hydrogen content when the purge valve is opened if water is discharged instead of gas. This is the case when the fill level in the water separator container has reached and exceeded a maximum fill level specified by the discharge point of the purge valve. When the purge valve is opened, water is first discharged until the water level falls below the discharge point of the purge valve again. During this time, no anode gas is discharged, so that no increase in the hydrogen content can be measured. A delayed increase in the hydrogen content can therefore be seen as an indication of a full container.

Full detection according to the proposed method does not require a level sensor, so that the method can be implemented simply and cost-effectively. The method only requires a hydrogen sensor downstream of the purge valve, which is usually available, so that full detection can be realized using the existing sensor technology.

If the “container full” state is detected during the method, this information is preferably used to calibrate a model that is used to determine the amount of water in the container. The model can be continuously calibrated in this way, so that the proposed method enables optimization of the control strategy of the drain valve.

Preferably, the measurement signals from the hydrogen sensor are transmitted to a control device for evaluation. The control device calculates the time of the increase in the hydrogen content from the measurement signals of the hydrogen sensor and compares this with the opening time of the purge valve. If the rise is delayed, the “container full” status is detected.

Preferably, the purge valve is controlled with the aid of the control device provided for evaluating the measurement signals. This means that the control device knows the opening time of the purge valve in order to carry out the adjustment.

Furthermore, the drain valve is preferably activated and opened when the “container full” status is detected. Water flows out of the container through the open drain valve so that the fill level falls below the discharge point of the purge valve again and the anode circuit can be purged with the aid of the purge valve. It is preferable to keep the drain valve open until the water separator container is completely empty. This means that a complete drainage process is initiated when the “container full” status is detected.

The drain valve is preferably activated with the aid of the control device, to which the measurement signals from the hydrogen sensor are transmitted. This means that when the “container full” status is detected, the drain valve can be opened to take direct countermeasures. This prevents the container from overflowing and/or water from getting back into the anode circuit.

To solve the task mentioned at the beginning, a control device is also proposed which is set up to carry out steps of the method according to the invention. For example, the control device can be used to evaluate the measurement signals from the hydrogen sensor. The measurement signals are transmitted to the control device for this purpose. The control device can also be used to control the purge valve so that the control device knows when the purge valve opens. Knowing the opening time of the purge valve, the control device can detect a delayed increase in the hydrogen content downstream of the purge valve, which indicates that the water separator container is full. If a full container is detected, the drain valve can be activated and opened using the control device to empty it.

### BRIEF DESCRIPTION OF THE DRAWINGS

The invention and its advantages are explained in more detail below with reference to the accompanying drawings. Shown are:

FIG. 1 a schematic representation of a water separator integrated in an anode circuit of a fuel cell system and

FIG. 2 a diagram showing the increase in hydrogen content when the purge valve is open as a function of the fill level in the water separator container.

### DETAILED DESCRIPTION

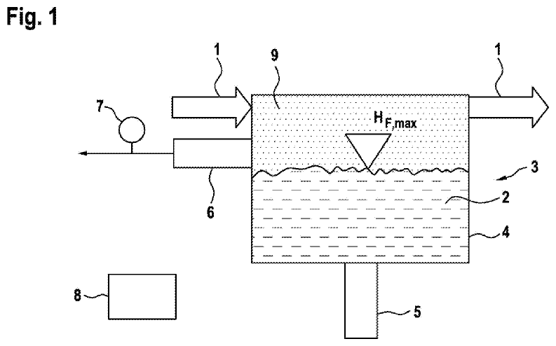

FIG. 1 shows an example of a water separator 3 that is integrated into an anode circuit 1 of a fuel cell system. The water separator 3 comprises a container 4 for collecting water 2, which is separated from the anode gas of the anode circuit 1 with the aid of the water separator 3. A drain valve 5 is provided at the bottom to empty the container 4. Furthermore, a purge valve 6 is arranged on the side of the container 4. The purge valve 6 can be used to purge the anode circuit 1 in order to remove nitrogen-enriched anode gas from the anode circuit 1. However, this presupposes that the fill level in the container 4 does not exceed a maximum fill level H_{F,max}, which is specified by the height of the purge valve 6. Otherwise, when the purge valve 6 is opened, water 2 will escape instead of gas 9 until the fill level H_{F,max} is reached again.

Since the gas 9 discharged via the purge valve 6 usually still contains hydrogen, the discharged gas is introduced into a cathode exhaust air stream for dilution. A hydrogen sensor 7 is provided downstream of the purge valve 6, which detects the hydrogen content. The measurement signals from the hydrogen sensor 7 are transmitted to a control device 8, which is also used to control the purge valve 6. The control device 8 therefore knows the opening time of the purge valve 6 and can calculate the time at which the hydrogen content downstream of the purge valve 6 increases from the measurement signals of the hydrogen sensor 7. If the increase does not occur when the purge valve 6 opens, but is delayed, this is an indication that the fill level in the container 4 is above H_{F,max} and water 2 is escaping via the purge valve 6 instead of gas 9. In this case, a drainage process can be initiated and the drain valve 5 can be opened.

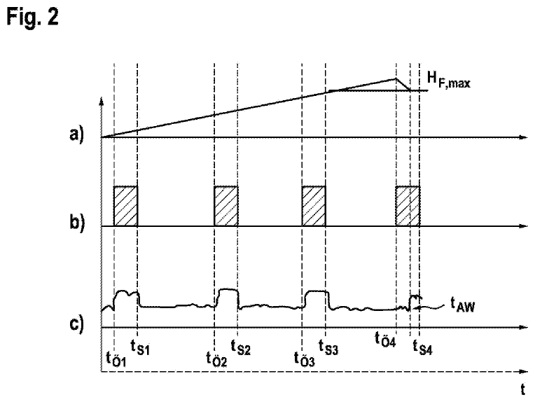

FIG. 2 shows that the fill level in the container 4 rises continuously over time t (see FIG. 2a)), namely over several opening cycles of the purge valve 6 (see FIG. 2b)). When the purge valve 6 is opened at the times [symbol] , [symbol] , [symbol] , and [symbol] , the hydrogen content increases downstream, which is measured using the hydrogen sensor 7. When the purge valve 6 is closed at the times t_{S1}, t_{S2}, t_{S3}, and t_{S4}, the hydrogen content drops again (see FIG. 2c)). However, when the purge valve 6 is opened for the last time, the hydrogen content does not increase until time t_{AW}, i.e., with a time delay compared to [symbol] . This is due to the fact that the fill level in the container 4 has reached a level above H_{F,max} (see FIG. 2a)), so that when the purge valve 6 is opened, water 2 and no gas 9 is initially discharged. Only when the fill level is below H_{F,max} again does gas 9 flow out, so that the hydrogen content downstream of purge valve 6 increases (see FIG. 2c)).

1. A method for operating a fuel cell system, wherein hydrogen-containing anode gas exiting at least one fuel cell is recirculated via an anode circuit (1), wherein liquid water (2) contained in the anode gas is separated via a water separator (3) integrated into the anode circuit (1), is collected in a container (4), and is removed from the container (4) by opening a drain valve (5), and the anode circuit (1) is flushed by opening a purge valve (6) integrated into the container (4) of the water separator (3), wherein the hydrogen content is measured via a hydrogen sensor (7) connected downstream of the purge valve (6),
wherein when the purge valve (6) is open and a delayed increase in the hydrogen content is detected via the hydrogen sensor (7), the “container full” state is detected.

2. The method according to claim 1, wherein the information “container full” is used to calibrate a model which is used to determine the amount of water in the container (4).

3. The method according to claim 1, wherein the measurement signals of the hydrogen sensor (7) are transmitted for evaluation to a control device (8), via which the purge valve (6) is actuated.

4. The method according to claim 1,
wherein the drain valve (5) is activated and opened when the “container full” state is detected.

5. A control device (8) configured to perform steps of the method according to claim 1.
